(19) United States
(12) Patent Application Publication
(10) Pub. No.: US 2026/0098960 A1
(43) Pub. Date: Apr. 9, 2026

(54) ASSESSMENT OF BUILDING DAMAGES UNDER DIFFERENT GROUND SETTLEMENT MOVEMENTS USING MT-INSAR MONITORING TECHNIQUE

(71) Applicant: The Chinese University of Hong Kong, Hong Kong (CN)

(72) Inventors: Peifeng MA, Hong Kong (CN); Yi ZHENG, Hong Kong (CN); Guangen YE, Hong Kong (CN)

(21) Appl. No.: 19/352,787

(22) Filed: Oct. 8, 2025

Related U.S. Application Data
(60) Provisional application No. 63/704,647, filed on Oct. 8, 2024.

(51) Int. Cl. G01S 13/90

(52) U.S. Cl. CPC G01S 13/9023

(57) ABSTRACT

A Multi-temporal Interferometric Synthetic Aperture Radar method for jointly detecting persistent scatterers (PSs) and distributed scatterers (DSs) is provided. The method includes in a first-tier network, selecting a plurality of PSs if a value of temporal coherence of the PS is larger than a first predetermined threshold; performing beamforming and M-estimator to enhance robustness of parameter estimation; in a second-tier network, identifying new PSs from the plurality of PSs by performing same prior steps; continuously updating the network based on the newly selected PSs until the value of the temporal coherence is smaller than the first predetermined threshold; performing coherence-weight phase-linking to reconstruct optimal phases for detection of a distributed scatterer (DS); and identifying that a pixel is a DS if the temporal coherence is greater than a second predetermined threshold based on the reconstructed optimal phases. The method can be applied to assessment of building damages under different ground settlement movements.

### CROSS-REFERENCE TO RELATED APPLICATIONS

The present application claims the benefit of U.S. Provisional Application Ser. No. 63/704,647, filed Oct. 8, 2024, which is hereby incorporated by reference herein in its entirety, including any figures, tables, or drawings.

### BACKGROUND OF THE INVENTION

### I. Introduction

Building are main components of urban infrastructure, accommodating thousands of people. In alignment with the United Nation's 2030 agenda for Sustainable Development, which aims to “make cities and human settlement inclusive, safe, resilient and sustainable by 2030”, the safety of buildings is of great concern.

In China, while the designed lifespan for buildings is typically 50 years, investigations have shown that their practical lifespan averages about 30 years [1]. The discrepancy highlights the pressing need for continuously monitoring of building safety.

The common deformation measuring devices such as total stations, levels and 3D Laser scanner, monitor structure deformation in one, two or three dimensions [2]. While these techniques can provide accurate monitoring results for the target buildings, they can be time-consuming and difficult to implement over large areas.

Interferometric Synthetic Aperture Radar (InSAR) is a remote sensing technique for observing ground deformation. The microwave signals emitted can penetrate cloud by longer wavelength transmitting, allowing for acquisition of information over on large areas (thousands km²) in all-time, all-weather conditions [3]. With the high-resolution SAR satellites launched and the development of InSAR processing methods, the accuracy has improved to sub-millimeter per year [4]. This technique has been successfully applied in building damage monitoring [5], as demonstrated by a number of studies [6-9].

In these studies, buildings are always considered rigid bodies, only suffering tipping settlement damages. However, buildings may also experience Sagging or Hogging settlement damages due to the fluctuated ground movement. Although some research had addressed these types of damages [10, 11], methods to quantification of such damages using InSAR measurements are still lacking and have yet to be applied over large areas.

Limit state codes [12, 13] provide indicators to assess building damage. In terms of the evaluation results, Angular Distortion and Tensile Strain are considered two relatively appropriate indicators, which are neither the most conservative nor the least [11]. Angular Distortion has been widely used in assessing building damage using InSAR measurements, under the assumption that the building has only suffered tipping settlement. While Tensile Stain can indicate more building deformation performance, it is less commonly used.

### BRIEF SUMMARY OF THE INVENTION

There continues to be a need in the art for improved designs and techniques for assessment of building damages under different ground settlement movements.

According to an embodiment of the subject invention, a Multi-temporal Interferometric Synthetic Aperture Radar (MT-InSAR) method for jointly detecting persistent scatterers (PSs) and distributed scatterers (DSs) is provided. The method comprises in a first-tier network, selecting a plurality of persistent scatterers (PSs) if a value of temporal coherence of the PS is larger than a first predetermined threshold; performing beamforming and M-estimator to enhance robustness of parameter estimation; in a second-tier network, identifying new PSs from the plurality of PSs by performing same prior steps; continuously updating the network (first or second or both) based on the newly selected PSs until value of the temporal coherence is smaller than the first predetermined threshold; performing coherence-weight phase-linking (CWPL) to reconstruct optimal phases for detection of a distributed scatterer (DS); and identifying that a pixel is a DS if the temporal coherence is greater than a second predetermined threshold based on the reconstructed optimal phases. For TerraSAR-X and COSMO-SkyMed data, the first predetermined threshold is 0.78. Moreover, the performing CWPL comprises assigning a larger weight to a higher coherence phase if the higher coherence indicates higher quality of images. For TerraSAR-X and COSMO-SkyMed data, the second predetermined threshold is 0.68.

In another embodiment, a method for assessing building damages under different ground settlement movements is provided. The method comprises performing the MT-InSAR method described above; identifying building damage categories and extracting indicators; and assessing building risks by staged processes. The identifying building damage categories and extracting indicators comprises interpolating a cumulative deformation surface based on measurements obtained from the MT-InSAR method. Moreover, deformation planes beneath each building is treated as triggers for building damages. Types of damages vary depending on types of settlement areas. The assessing building risks by staged processes comprises setting a third predetermined threshold for maximum settlement to identify building with a Negligible level of damage directly; calculating tensile strain; and determining building damage levels. The third predetermined threshold is set to 8 mm.

In certain embodiment, a non-transitory computer readable medium having stored therein program instructions executable by a computing system to cause the computing system to perform a Multi-temporal Interferometric Synthetic Aperture Radar (MT-InSAR) method for jointly detecting persistent scatterers (PSs) and distributed scatterers (DSs), the method comprises in a first-tier network, selecting a plurality of persistent scatterers (PSs) if a value of temporal coherence of the PS is larger than a first predetermined threshold; performing beamforming and M-estimator to enhance robustness of parameter estimation; in a second-tier network, identifying new PSs from the plurality of PSs by performing same prior steps; continuously updating the network (first or second or both) based on the newly selected PSs until value of the temporal coherence is smaller than the first predetermined threshold; performing coherence-weight phase-linking (CWPL) to reconstruct optimal phases for detection of a distributed scatterer (DS); and identifying that a pixel is a DS if the temporal coherence is greater than a second predetermined threshold based on the reconstructed optimal phases. For TerraSAR-X and COSMO-SkyMed data, the first predetermined threshold is 0.78. The performing CWPL comprises assigning a larger weight to a higher coherence phase if the higher coherence indicates higher quality of images. Moreover, for TerraSAR-X and COSMO-SkyMed data, the second predetermined threshold is 0.68.

In another embodiment, a non-transitory computer readable medium having stored therein program instructions executable by a computing system to cause the computing system to perform a method for assessing building damages under different ground settlement movements, the method comprises performing the MT-InSAR method described above; identifying building damage categories and extracting indicators; and assessing building risks by staged processes. The identifying building damage categories and extracting indicators comprises interpolating a cumulative deformation surface based on measurements obtained from the MT-InSAR method. Deformation planes beneath each building is treated as triggers for building damages. Types of damages vary depending on types of settlement areas. Moreover, the assessing building risks by staged processes comprises setting a third predetermined threshold for maximum settlement to identify building with a Negligible level of damage directly; calculating tensile strain; and determining building damage levels. The third predetermined threshold is set to 8 mm.

### BRIEF DESCRIPTION OF THE DRAWINGS

FIGS. 1A-1D show schematic representations of building damage under Hogging (FIG. 1A) and Sagging (FIG. 1B) conditions; and schematic representations of building deformation points scanning (FIG. 1C) and corresponding deformation parameters extraction (FIG. 1D), according to an embodiment of the subject invention.

FIGS. 2A-2B show InSAR measurements results of TerraSAR-X from Mar. 21, 2012 to Mar. 28, 2014 (FIG. 2A) and COSMO-SkyMed from Jan. 28, 2014 to Mar. 22, 2016 (FIG. 2B), according to an embodiment of the subject invention.

FIGS. 3A-3B show the time series of homogeneity points of P1 (FIG. 3A) and P2 (FIG. 3B), according to an embodiment of the subject invention.

FIGS. 4A-4B show a building damage level map (FIG. 4A) and a corresponding building settlement bend type map (FIG. 4B), according to an embodiment of the subject invention.

FIGS. 5A-5B show a heatmap of R² and Sample point count (FIG. 5A) and four selected buildings' deformation surfaces and profiles (FIG. 5B), according to an embodiment of the subject invention.

TABLE I
DAMAGE AND CORRESPONDING SLS
INDICATORS (2012-2016)

| Category | | Maximum settlement/ | Tensile strain/ |
|---|---|---|---|
| of damage | Damage level | Dₘₐₓ [mm] | ϵ [%] |
| 0 | Negligible | ≤8 | — |
| 1 | Very Slight | — | >0.006 |
| 2 | Slight | — | 0.006-0.012 |
| 3 | Moderate | — | 0.012-0.024 |
| 4 | Severe | — | >0.024 |

### DETAILED DISCLOSURE OF THE INVENTION

The embodiments of subject invention pertain to a surface deformation monitoring method and systems based on time-series InSAR (TS-InSAR).

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. 20

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

According to embodiments of the subject invention, a method is provided for extracting building indicators related to Tensile Strain. Different settlement types, which may influence the performance of building damage, are also identified based on them.

The description of the subject invention is organized into two sections. In Section I, the InSAR evaluation method is introduced, then the method to evaluate building damage is stated in detail. In Section II, high-resolution SAR image datasets are integrated to provide comprehensive monitoring deformation data. The InSAR measurements results and building damage maps are presented.

### Materials and Methods

Building damage can result from various driving forces, both natural and anthropogenic, posing significant threats to human life and requiring continuous monitoring. Compared to conventional engineering investigations, interferometric synthetic aperture radar (InSAR) is an effective technique for monitoring deformation over large-scale areas. However, the current application of InSAR in assessing building damage is constrained, as it often fails to account for building bend when deformation varies across different structures.

Moreover, different types of damage can occur due to varying settlement. Herein, the potential for building bend damage under fluctuated ground movement is considered. A method is provided to extract relative building damage indicators from InSAR measurement is provided. This approach is applied to an urban area of Hong Kong, where the damage levels and types are identified and displayed on maps. The assessment results are then evaluated to discuss the effectiveness of this method.

### I. Methodology

### A. Robust MT-InSAR to Detect PSs and DSs

A robust multi-temporal Interferometric Synthetic Aperture Radar (MT-InSAR) method for jointly detecting persistent scatterers (PSs) and distributed scatterers (DSs) is provided to detect scatterers. The atmospheric phase screen (APS) is removed through subtracting the adjacent points phase. Thus, the inversion equation can be written without APS as:

$$y = A γ \qquad ( 1 )$$

where y=[y₁, . . . , yₙ]^{T} (n is the number of SAR images, [⋅]\hat{ }T) is the transport operation representing the differential interferograms, and y is the reflectivity vector. A is the parameter matrix that should be estimated, including relative height and deformation velocity. This method requires selection of one most reliable PS before constructing a two-tier network to detect PSs and DSs. In the first-tier network, a plurality of primary PS candidates are selected if their temporal coherence is larger than a threshold (for example, 0.78 for TerraSAR-X and COSMO-SkyMed).

In one embodiment, the threshold is set to 0.78 for selecting candidate scatterers in the first-tier network. In general, in the first-tier network, the candidate scatterers are selected for being spatially well distributed and are considered most stable points. The higher temporal coherence, the more stable a scatterer is. The threshold 0.78 is an empirical threshold which enables the selection of stable candidate points of high quality. However, if the quality of the results is not high or fewer candidate points are selected, the value of the threshold can be adjusted downward appropriately, and any value above 0.7 for the threshold is acceptable.

Further, the beamforming and M-estimator are employed to enhance robustness of parameter estimation. All the primary PSs are used to identify new PSs by following the same process for the second-tier network. Newly selected PSs continuously update the network until the temporal coherence is smaller than the threshold. Subsequently, the coherence-weight phase-linking (CWPL) method is used to reconstruct phases for DSs detection [15]. The CWPL method can assign a larger weight to a higher-coherence phase if the higher coherence indicates higher quality of images. Then, the reconstructed optimal phases are used to identify whether a pixel is a DS by a temporal coherence threshold (for example, 0.68 for TerraSAR-X and COSMO-SkyMed data). The phase randomness of distributed scatterers (DSs) is large, and phase reconstruction of DS targets is a key processing step to extract information from DS pixels. It refers to the estimation of a single primary image phase sequence by using the interferometric phases of a number of multi-images at each pixel. The estimated phases contain only the phases associated with path-length difference terms between the target and the sensor, thus realizing the removal of de-correlated noise from the interferometric phases. The phase associated with the path length difference term is used to achieve the removal of de-correlated noise from the interferometric phase. Due to the entanglement property of the observed phase itself, the functional relationship between the observed signal and the unknown parameter is highly nonlinear. Thus, more and more advanced methods are needed. To address this problem, many estimation methods have been proposed, and they solve the problems of the signal reconstruction of entangled phases through different concepts and mathematical methods. Regardless of the mathematical methods used to reconstruct the entangled phase, these methods are based on the fundamental assumption of phase triangularity. Based on the principles of PS selection, once the phase of a pixel is greater than the temporal coherence of reconstructed phase, the pixel could be regarded as a DS.

In one embodiment, the beamforming process is performed as described below. To identify how many Persistent Scatterers (PSs) are present in one pixel, the tomography y is first reconstructed. The inversion can be written in a general manner:

$$\hat{γ} ( s , v , k ) = \frac{\vert {a ( s , v , k )}^{H} y \vert}{{‖ a ( s , v , k ) ‖}_{2} {‖ y ‖}_{2}}$$

where ∥⋅∥₂ is 2-norm. Note that the tomographic magnitude in the equation has been normalized. By identifying the peaks in the normalized tomographic magnitude (NTM), how many PSs interfere in the pixel, which is commonly involved in a model selection procedure, can be determined.

In one embodiment, the M-estimator process is performed as described below.
Step 1. Set the iteration count l=0 and the initial weight matrix W as the identity matrix I, as follows:

$${W}^{l = 0} = {I}_{M}$$

Step 2. Determine the weighed least square estimates:

$${\hat{J}}^{l} = {( {D}^{T} {W}^{l} D )}^{- 1} {D}^{T} {W}^{l} Δ ϕ$$

Note that, when l=0, this is an unweighted estimator.
Step 3. Calculate the residual phase

$${r}^{l} = {[ {r}_{1}^{l} , … , {r}_{N}^{l} ]}^{T}$$

and the associated weight matrix

$${W}^{l + 1} = diag \{ {ω}_{i}^{l + 1} \} ,$$

as follows:

$${r}^{l} = Δ ϕ - D {\hat{J}}^{l}$$

$${ω}_{i}^{l + 1} = \{ \begin{matrix}1 , \\ \frac{{C}_{M - estimator}}{\vert {r}_{i}^{l} \vert}\end{matrix}$$

$${ω}_{i}^{l + 1} = \{ \begin{matrix}1 , & for \vert {r}_{i}^{l} \vert \leq {C}_{M - estimator} \\ \frac{{C}_{M - estimator}}{\vert {r}_{i}^{l} \vert} , & for \vert {r}_{i}^{l} \vert \leq {C}_{M - estimator}\end{matrix}$$

the constant C_{M-estimator} is usually set to be 1.345.
Step 4. Terminate on convergence; otherwise, set l=l+1 and go to Step 2.

### B. Building Damage Categories Identification and Indicator Extraction

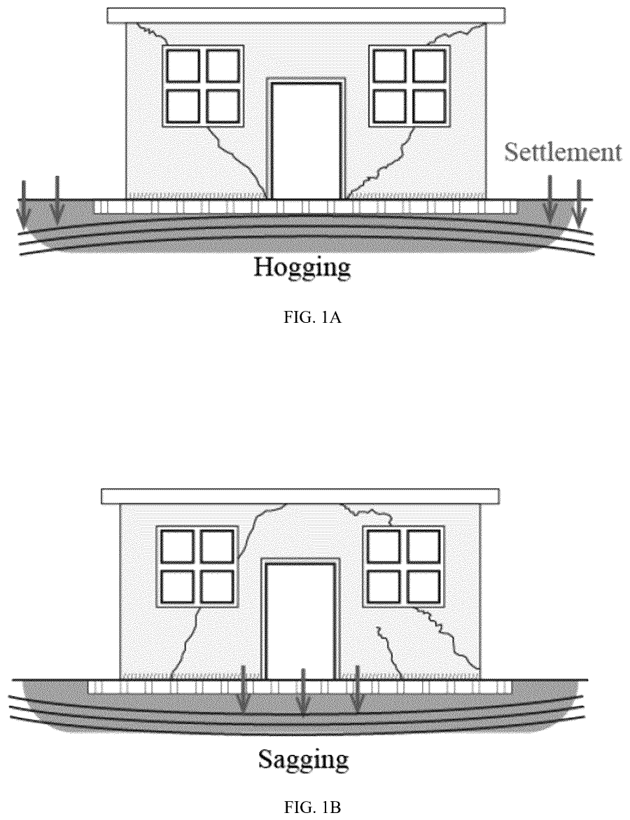

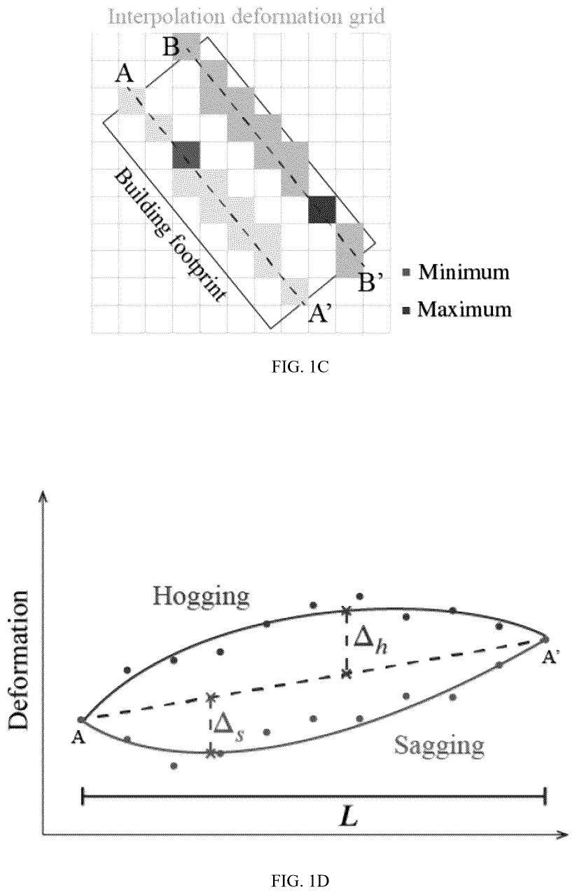

Based on the InSAR measurements, a cumulative deformation surface could be interpolated using Krigin, with the deformation plane beneath each building considered as the trigger for building damage. The type of damage may vary depending on the kind of settlement area, as shown in FIGS. 1A and 1B.

Sagging settlement causes building convex bending, while hogging causes building concave-upward bending. Both can lead to cracks. To describe the curvature, one representative profile is extracted for each building. As shown in FIG. 1C, all the pixels along the line that crosses the extreme point and runs parallel to building facade are selected. The extreme point is selected from the maximum point and the minimum point, depending on the sign of median of all points belong to the building. Then the selected pixel is used to represent deformation profile of a building and a polynomial regression model with degree of 2 is used to fit it. The goodness of the fit can be evaluated based on a R-square (R²) metric, which can be written as:

$${R}^{2} = 1 - \frac{\sum {( {y}_{i} - {\hat{y}}_{i} )}^{2}}{\sum {( {y}_{i} - \overline{y} )}^{2}} \qquad ( 2 )$$

where yᵢ is the pixel value, ŷᵢ is the predicted value from the regression model, and y̅ is the mean value.

With the fitted curve, the maximum deformation (Δ) in sagging (Δₛ) and in hogging (Δₕ) can be derived. Tensile strain, including bending strain (ϵ_{b}) and diagonal strain (ϵ_{d}), is calculated accordingly for Sagging and Hogging. In Sagging settlement:

$${ϵ}_{{b}_{s}} = \frac{\frac{{Δ}_{s}}{L}}{( \frac{L}{6 H} + \frac{HE}{4 LG} )} \qquad ( 3 )$$

$${ε}_{{d}_{s}} = \frac{\frac{{Δ}_{s}}{L}}{( 1 + \frac{2 {L}^{2} G}{3 {H}^{2} E} )} \qquad ( 4 )$$

and in Hogging:

$${ϵ}_{{b}_{h}} = \frac{\frac{{Δ}_{h}}{L}}{( \frac{L}{12 H} + \frac{HE}{2 LG} )} \qquad ( 5 )$$

$${ϵ}_{{d}_{h}} = \frac{\frac{{Δ}_{h}}{L}}{( 1 + \frac{{L}^{2} G}{6 {H}^{2} E} )} \qquad ( 6 )$$

where L is the length of the building facade, H is building height, E and G are the Young's modules and Shear modulus of buildings, and a ratio E/G of 2.6 is often used when buildings are masonry [16], which is consistent with an isotropic Poisson's ratio 0.3. Since frame buildings are commonly considered in the context of Hong Kong, a ratio of 12.5 are more appropriate than 2.6 [17]. The maximum tensile strain is then calculated from either ϵ_{b} and ϵ_{d}, so the ϵₗᵢₘ is given by:

$${ϵ}_{lim} = max ( {ϵ}_{b} , {ϵ}_{d} ) \qquad ( 7 )$$

### C. Staged Process of Assessing Building Risk

The staged assessment approach is adopted, including three steps for assessing building damage levels. The preliminary assessment sets a threshold for maximum settlement to identify building with Negligible directly. For example, the threshold is set to 8 mm considering that settlement velocity of 2 mm/yr is acceptable. Then in the second stage assessment, tensile strain is calculated. Building damage levels are determined based on [18], drawing on the UK National Coal Board and relative works [20, 21]. Considering that these limit codes are designed for the whole building lifespan (50 years in China), they may be converted to fit the four years of InSAR measurements.

As shown in Table I, building damage level is divided into five categories. In particular, buildings at a Negligible level have hairline cracks in wall. At a Very Slight level, buildings have isolated slight cracking in walls, but are still not noticeable. At a Slight level, the hair cracks of buildings are generally noticeable. Buildings suffered from damages of a Moderate level appear slight fracturing (cracks up to 3 mm wide) that are apparently visible from the outside. Levels from Slight to Moderate indicate that the building requires repair, while buildings at higher levels such as a Severe level, open show fractures (15-25 mm) that require breaking-out and replacing section of walls [22].

### II. Results and Discussion

### A. Deformation Estimation by MT-InSAR

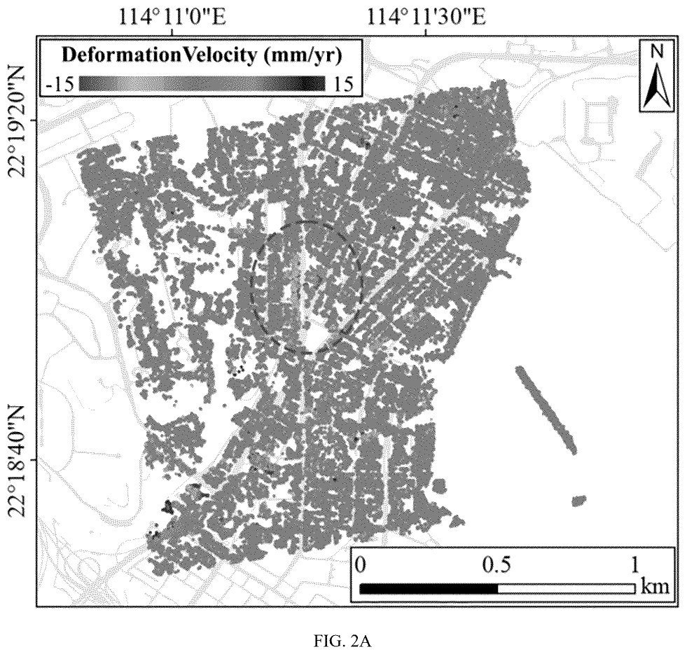

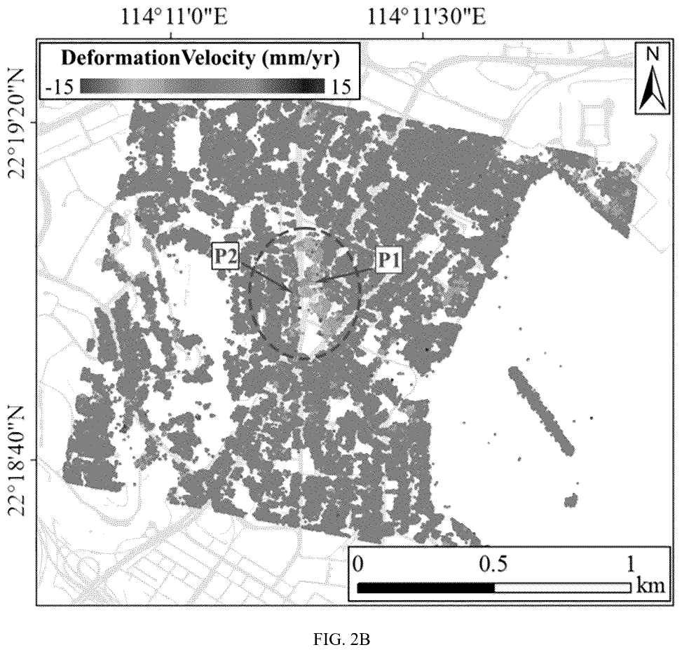

X-band SAR satellite images with a resolution of 3 m×3 m are used, which cover the urban area of Kowloon, Hong Kong. Specifically, there are 39 ascending TerraSAR-X images acquired from Mar. 21, 2012 to Mar. 28, 2014, and 30 descending COSMO-SkyMed images acquired from Jan. 28, 2014 to Mar. 22, 2016. SAR images captured on Apr. 21, 2013 and Jan. 15, 2015 are selected as the master images. The results generate density scatterers from TerraSAR-X and COSMO-SkyMed with the point number of 228,420 and 208,586, respectively. In addition, the TerraSAR-X estimated deformation velocity ranges from −25.3 to 20.2 mm/yr, and the COSMO-SkyMed estimated deformation velocity ranges from −19.5 to 13.2 mm/yr. As shown in FIGS. 2A-2B, the blue pints indicate apparent movement towards satellites, while the red ones indicate movement away from satellites along LOS directions. The moving points are centrally located within the red dashed circle. The results are consistent with the situation that an underground construction is carried out during this period. LiDAR is used to validate the estimated height of InSAR results, with a Root-Mean-Square-Error (RMSE) of 5.1 m and 6.1 m, indicating that the results are accuracy.

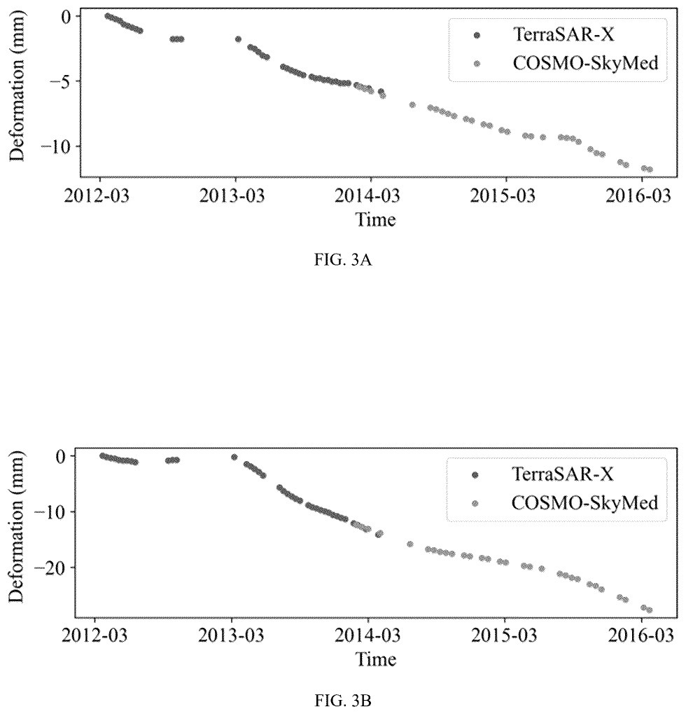

Through matching the nearest points within 10 m between two datasets, totally 74,930 pairs of homogeneity points are identified. Two pairs of homogeneity (P1 and P2) are selected to display time series. As shown in FIGS. 3A-3B, the overlap between the two time series indicate the coherence in terms of cumulative deformation. Accordingly, the cumulative deformation from Mar. 21, 2012 to Mar. 22, 2016 can be calculated.

### B. Building Damage Assessment

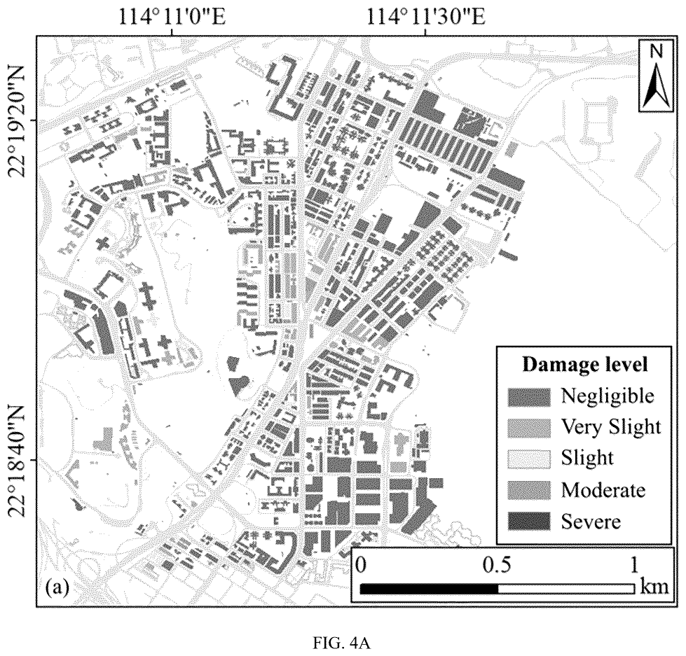

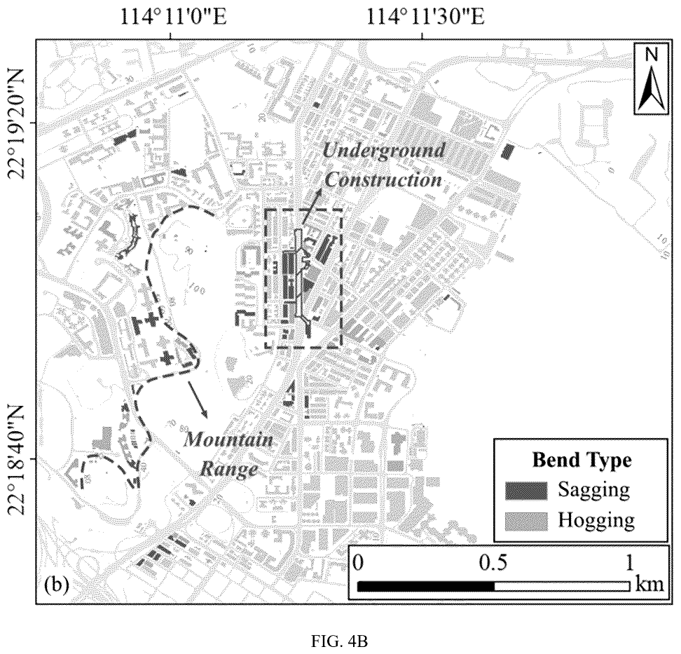

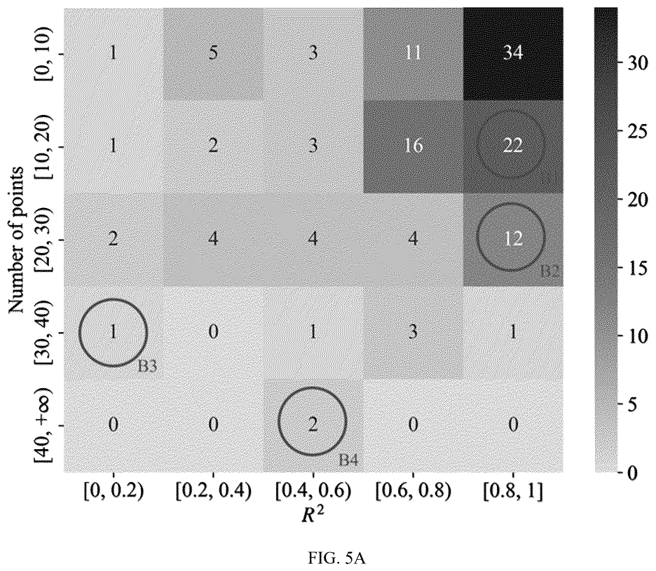

Building damage levels have been assessed through structure tensile strain calculation. A total of 807 buildings are successfully assessed for the designated area. As shown in FIG. 4A, with the number of 675, most buildings are at the Negligible level. The number of buildings at the Very Slight level is 88, while the number of buildings at the Slight level is 25. These buildings are mainly located in the central and eastern parts of the designated area. In addition, 19 buildings at a Moderate damage level are in the central and sporadically distributed in the eastern part. Buildings at damage levels above the Negligible require repair or pose damage. There are totally 132 such buildings and the corresponding settlement types are display in FIG. 4B. 62 of them are in the Sagging settlement and 70 of them are in the Hogging settlement. The damaged buildings in the central part are mainly located in the red dashed rectangle.

Similar to the apparent deformation observed in FIGS. 2A-2B, the distribution may be induced by an underground construction during this period. Moreover, the building distribution indicates that the those adjacent to the construction site are mostly in Sagging settlement, while those slightly farther away are in Hogging settlement. This distribution pattern is highly consistent with the “greenfield settlement profile” typically observed near underground construction site [17]. The damaged buildings in the eastern part are located along the mountains, as indicated by the red dash line in FIG. 4B. These damages may be induced by slopes or landslides.

### C. Discussion

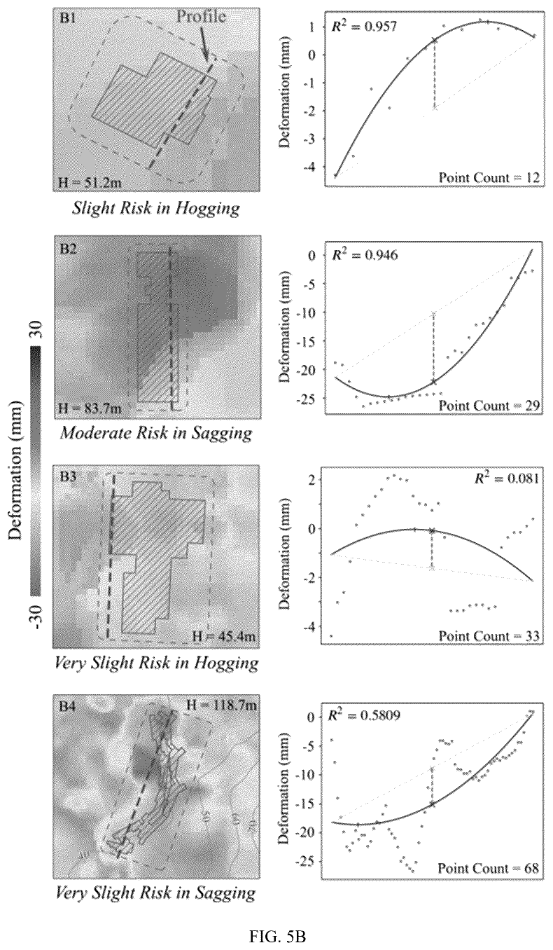

R² of the regression curves of all the 132 damaged buildings is calculated to assess the proposed rationales. A heatmap between the regression curve's R² and corresponding number of sample points are shown in FIG. 5A. It is seen that all the buildings with the number of sample points below 100 with a maximum of 68. In regression models with a small size, it is generally considered that an R² value above 0.6 is a good indicator for explanatory purposes. 103 buildings, or approximately 78% of the sample, have R² values above 0.6, approximately 78%, suggesting the method's broad applicability.

Two buildings (B1 and B2) are selected to show the detail information. B1 is a nearly square, 51.2 m building. It is in an area with of minor settlement and the maximum cumulative settlement value is only nearly 4 mm. However, with the uneven settlement, the building is in Hogging settlement and at the Slight damage level. With an R² value of 0.957, the result is considered to be credible. B2 is a building with long facade, with the height of 83.7 m. It is in an area with greater settlement. The maximum settlement is more than 25 mm. The uneven settlement made it suffer Sagging settlement and in the risk of a Moderate level. With the R² value of 0.946, this result is also credible. Therefore, the building requires repair, with a focus on the bottom parts of the facade.

There are four buildings with larger numbers of sample points but with low R² values. As shown in FIG. 5B, two of them (B3 and B4) are selected. B3 is a building with long facade along the north-south direction. Its corresponding regression curve approximately fits the trend of the deformation points. The result indicates that it is in Hogging settlement at a Very Slight damage level. However, based on the discrete points, it can be observed that both hogging and sagging are present in this profile. This complexity requires fitting a higher degree polynomial regression model. B4 is a 118.7 m building with long curve facade. Its profile follows a northeast-southeast direction. The building's footprint is complex, curving approximately along the 40 m contour of the terrain. Same as B3, the regression curve approximately fits trend. However, the practical deformation profile is more fluctuated and may need fitting higher degree regression model.

In one embodiment, a method is provided for deriving building damage information from InSAR measurements considering building's beam bend. The accuracy of InSAR measurements and the density of detected points are crucial prerequisites, and the good results are ensured by employing the robust MT-InSAR method described in Section I-A. The InSAR results are then used to interpolate and extract building damage indicators using the method described in Section I-B. The results successfully display the damage levels and settlement types through staged process of assessing building risk mentioned in Section I-C. Every building with a risky level has R² to indicate the result's credibility. It is found that buildings with long and complexity facade may have a lower credible assessment.

### EXEMPLARY EMBODIMENTS

Embodiment 1. A Multi-temporal Interferometric Synthetic Aperture Radar (MT-InSAR) method for jointly detecting persistent scatterers (PSs) and distributed scatterers (DSs), the method comprising:
in a first-tier network, selecting a plurality of persistent scatterers (PSs) if a value of temporal coherence of the PS is larger than a first predetermined threshold;
performing beamforming and M-estimator to enhance robustness of parameter estimation;
in a second-tier network, identifying new PSs from the PSs by performing same prior steps;
continuously updating the network (first-tier or second-tier or both) based on the newly selected PSs until the value of the temporal coherence is smaller than the first predetermined threshold;
performing coherence-weight phase-linking (CWPL) to reconstruct optimal phases for detection of a distributed scatterer (DS); and
identifying that a pixel is a DS if the temporal coherence is greater than a second predetermined threshold based on the reconstructed optimal phases.

Embodiment 2. The method of embodiment 1, wherein for TerraSAR-X and COSMO-SkyMed data, the first predetermined threshold is 0.78.

Embodiment 3. The method of any preceding embodiment, wherein the performing CWPL comprises assigning a larger weight to a higher coherence phase if the higher coherence indicates higher quality of images.

Embodiment 4. The method of any preceding embodiment, wherein for TerraSAR-X and COSMO-SkyMed data, the second predetermined threshold is 0.68.

Embodiment 5. A method for assessing building damages under different ground settlement movements, the method comprising:
performing the MT-InSAR method of any preceding embodiment;
identifying building damage categories and extracting indicators; and
assessing building risks by staged processes.

Embodiment 6. The method of embodiment 5, wherein the identifying building damage categories and extracting indicators comprises interpolating a cumulative deformation surface based on measurements obtained from the MT-InSAR method.

Embodiment 7. The method of any preceding embodiment, wherein deformation planes beneath each building are treated as triggers for building damages.

Embodiment 8. The method of any preceding embodiment, wherein types of damages vary depending on types of settlement areas.

Embodiment 9. The method of any preceding embodiment, wherein the assessing building risks by staged processes comprises:
setting a third predetermined threshold for maximum settlement to identify building with a Negligible level of damage directly;
calculating tensile strain; and
determining building damage levels.

Embodiment 10. The method of embodiment 9, wherein the third predetermined threshold is set to 8 mm.

Embodiment 11. A non-transitory computer readable medium having stored therein program instructions executable by a computing system to cause the computing system to perform a Multi-temporal Interferometric Synthetic Aperture Radar (MT-InSAR) method for jointly detecting persistent scatterers (PSs) and distributed scatterers (DSs), the method comprising:
in a first-tier network, selecting a plurality of persistent scatterers (PSs) if a value of temporal coherence of the PS is larger than a first predetermined threshold;
performing beamforming and M-estimator to enhance robustness of parameter estimation;
in a second-tier network, identifying new PSs from the plurality of PSs by performing same prior steps;
continuously updating the network (first-tier or second-tier or both) based on the newly selected PSs until the value of the temporal coherence is smaller than the first predetermined threshold;
performing coherence-weight phase-linking (CWPL) to reconstruct optimal phases for detection of a distributed scatterer (DS); and
identifying that a pixel is a DS if the temporal coherence is greater than a second predetermined threshold based on the reconstructed optimal phases.

Embodiment 12. The non-transitory computer readable medium of embodiment 11, wherein for TerraSAR-X and COSMO-SkyMed data, the first predetermined threshold is 0.78.

Embodiment 13. The non-transitory computer readable medium of any preceding embodiment, wherein the performing CWPL comprises assigning a larger weight to a higher coherence phase if the higher coherence indicates higher quality of images.

Embodiment 14. The non-transitory computer readable medium of any preceding embodiment, wherein for TerraSAR-X and COSMO-SkyMed data, the second predetermined threshold is 0.68.

Embodiment 15. A non-transitory computer readable medium having stored therein program instructions executable by a computing system to cause the computing system to perform a method for assessing building damages under different ground settlement movements, the method comprising:
performing the MT-InSAR method of any preceding embodiment;
identifying building damage categories and extracting indicators; and
assessing building risks by staged processes.

Embodiment 16. The non-transitory computer readable medium of embodiment 15, wherein the identifying building damage categories and extracting indicators comprises interpolating a cumulative deformation surface based on measurements obtained from the MT-InSAR method.

Embodiment 17. The non-transitory computer readable medium of any preceding embodiment, wherein deformation planes beneath each building are treated as triggers for building damages.

Embodiment 18. The non-transitory computer readable medium of any preceding embodiment, wherein types of damages vary depending on types of settlement areas.

Embodiment 19. The non-transitory computer readable medium of embodiment 15, wherein the assessing building risks by staged processes comprises:
setting a third predetermined threshold for maximum settlement to identify building with a Negligible level of damage directly;
calculating tensile strain; and
determining building damage levels.

Embodiment 20. The non-transitory computer readable medium of embodiment 19, wherein the third predetermined threshold is set to 8 mm.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] J. Wang, Y. Zhang, and Y. Wang, “Environmental impacts of short building lifespans in China considering time value,” Journal of Cleaner Production, vol. 203, pp. 696-707, 2018.
[2] E. S. Okiemute, M. N. Ono, and O. F. Oduyebo, “Comparative analysis of dgps and total station accuracies for static deformation monitoring of engineering structures,” Ono, M N, Eteje, S O and Oduyebo, F O (2018): Comparative Analysis of DGPS and Total Station Accuracies for Static Deformation Monitoring Of Engineering Structures IOSR Journal of Environmental Science, Toxicology and Food Technology (IOSR-JESTFT), vol. 12, no. 6, pp. 19-29, 2018.
[3] A. Hooper, D. Bekaert, K. Spaans, and M. Ankan, “Recent advances in SAR interferometry time series analysis for measuring crustal deformation,” Tectonophysics, vol. 514, pp. 1-13, 2012.
[4] A. Ferretti, C. Prati, and F. Rocca, “Permanent scatterers in SAR interferometry,” IEEE Transactions on geoscience and remote sensing, vol. 39, no. 1, pp. 8-20, 2001.
[5] M. P. Sanabria et al., “Subsidence activity maps derived from DInSAR data: Orihuela case study,” Natural Hazards and Earth System Sciences, vol. 14, no. 5, pp. 1341-1360, 2014.
[6] F. Cigna and D. Tapete, “Present-day land subsidence rates, surface faulting hazard and risk in Mexico City with 2014-2020 Sentinel-1 IW InSAR,” Remote Sensing of Environment, vol. 253, p. 112161, 2021.
[7] P. Ezquerro et al., “Vulnerability assessment of buildings due to land subsidence using InSAR data in the ancient historical city of Pistoia (Italy),” Sensors, vol. 20, no. 10, p. 2749, 2020.
[8] A. Miano et al., “GIS integration of DInSAR measurements, geological investigation and historical surveys for the structural monitoring of buildings and infrastructures: an application to the Valco San Paolo urban area of Rome,” Infrastructures, vol. 7, no. 7, p. 89, 2022.
[9] P. Ma, Y. Zheng, Z. Zhang, Z. Wu, and C. Yu, “Building risk monitoring and prediction using integrated multi-temporal InSAR and numerical modeling techniques,” International Journal of Applied Earth Observation and Geoinformation, vol. 114, p. 103076, 2022.
[10] V. Cerchiello, G. Tessari, E. Velterop, P. Riccardi, M. Defilippi, and P. Pasquali, “Building damage risk by modeling interferometric time series,” IEEE Geoscience and Remote Sensing Letters, vol. 14, no. 4, pp. 509-513, 2017.
[11] A. Drougkas et al., “Country-scale InSAR monitoring for settlement and uplift damage calculation in architectural heritage structures,” Structural Health Monitoring, vol. 20, no. 5, pp. 2317-2336, 2021.
[12] H. E. Wahls, “Tolerable deformations,” in Vertical and horizontal deformations of foundations and embankments, 1994: ASCE, pp. 1611-1628.
[13] L. Zhang and A. M. Ng, “Limiting tolerable settlement and angular distortion for building foundations,” in Probabilistic applications in geotechnical engineering, 2007, pp. 1-11.
[14] P. Ma and H. Lin, “Robust detection of single and double persistent scatterers in urban built environments,” IEEE Transactions on Geoscience and Remote Sensing, vol. 54, no. 4, pp. 2124-2139, 2015.
[15] B. Zhang, R. Wang, Y. Deng, P. Ma, H. Lin, and J. Wang, “Mapping the Yellow River Delta land subsidence with multitemporal SAR interferometry by exploiting both persistent and distributed scatterers,” ISPRS Journal of Photogrammetry and Remote Sensing, vol. 148, pp. 157-173, 2019.
[16] J. B. Burland and C. Wroth, “Settlement of buildings and associated damage,” 1975.
[17] R. Mair, R. Taylor, and J. Burland, “Prediction of ground movements and assessment of risk of building damage due to bored tunnelling,” in Geotechnical aspects of underground construction in soft ground, 1996, pp. 713-718.
[18] J. B. Burland, B. B. Broms, and V. F. De Mello, “Behaviour of foundations and structures,” 1978.
[19] G. Britain. Subsidence Engineers' Handbook. (1975). {The Board}.
[20] J. Jennings and J. Kerrich, “The heaving of buildings and the associated economic consequences, with particular reference to the Orange Free State goldfields,” Civil Engineering=Siviele Ingenieurswese, vol. 1962, no. 11, pp. 221-248, 1962.
[21] I. Macleod and G. Littlejohn, “Discussion on session 5,” in Conf on settlement of structures, Cambridge, Pentech Press, London, 1974, pp. 792-795.
[22] Cooper and A. H, “The classification, recording, databasing and use of information about building damage caused by subsidence and landslides,” Quarterly Journal of Engineering Geology and Hydrogeology, vol. 41, pp. 409-424, 2008, Art no. 3.

We claim:

1. A Multi-temporal Interferometric Synthetic Aperture Radar (MT-InSAR) method for jointly detecting persistent scatterers (PSs) and distributed scatterers (DSs), the method comprising:
in a first-tier network, selecting a plurality of persistent scatterers (PSs) if a value of temporal coherence of the PS is larger than a first predetermined threshold;
performing beamforming and M-estimator to enhance robustness of parameter estimation;
in a second-tier network, identifying new PSs from the PSs by performing same prior steps;
continuously updating the network (first-tier or second-tier or both) based on the newly selected PSs until the value of the temporal coherence is smaller than the first predetermined threshold;
performing coherence-weight phase-linking (CWPL) to reconstruct optimal phases for detection of a distributed scatterer (DS); and
identifying that a pixel is a DS if the temporal coherence is greater than a second predetermined threshold based on the reconstructed optimal phases.

2. The method of claim 1, wherein for TerraSAR-X and COSMO-SkyMed data, the first predetermined threshold is 0.78.

3. The method of claim 1, wherein the performing CWPL comprises assigning a larger weight to a higher coherence phase if the higher coherence indicates higher quality of images.

4. The method of claim 1, wherein for TerraSAR-X and COSMO-SkyMed data, the second predetermined threshold is 0.68.

5. A method for assessing building damages under different ground settlement movements, the method comprising:
performing the MT-InSAR method of claim 1;
identifying building damage categories and extracting indicators; and
assessing building risks by staged processes.

6. The method of claim 5, wherein the identifying building damage categories and extracting indicators comprises interpolating a cumulative deformation surface based on measurements obtained from the MT-InSAR method.

7. The method of claim 6, wherein deformation planes beneath each building are treated as triggers for building damages.

8. The method of claim 6, wherein types of damages vary depending on types of settlement areas.

9. The method of claim 5, wherein the assessing building risks by staged processes comprises:
setting a third predetermined threshold for maximum settlement to identify building with a Negligible level of damage directly;
calculating tensile strain; and
determining building damage levels.

10. The method of claim 9, wherein the third predetermined threshold is set to 8 mm.

11. A non-transitory computer readable medium having stored therein program instructions executable by a computing system to cause the computing system to perform a Multi-temporal Interferometric Synthetic Aperture Radar (MT-InSAR) method for jointly detecting persistent scatterers (PSs) and distributed scatterers (DSs), the method comprising:
in a first-tier network, selecting a plurality of persistent scatterers (PSs) if a value of temporal coherence of the PS is larger than a first predetermined threshold;
performing beamforming and M-estimator to enhance robustness of parameter estimation;
in a second-tier network, identifying new PSs from the plurality of PSs by performing same prior steps;
continuously updating the network (first-tier or second-tier or both) based on the newly selected PSs until the value of the temporal coherence is smaller than the first predetermined threshold;
performing coherence-weight phase-linking (CWPL) to reconstruct optimal phases for detection of a distributed scatterer (DS); and
identifying that a pixel is a DS if the temporal coherence is greater than a second predetermined threshold based on the reconstructed optimal phases.

12. The non-transitory computer readable medium of claim 11, wherein for TerraSAR-X and COSMO-SkyMed data, the first predetermined threshold is 0.78.

13. The non-transitory computer readable medium of claim 11, wherein the performing CWPL comprises assigning a larger weight to a higher coherence phase if the higher coherence indicates higher quality of images.

14. The non-transitory computer readable medium of claim 11, wherein for TerraSAR-X and COSMO-SkyMed data, the second predetermined threshold is 0.68.

15. A non-transitory computer readable medium having stored therein program instructions executable by a computing system to cause the computing system to perform a method for assessing building damages under different ground settlement movements, the method comprising:
performing the MT-InSAR method of claim 1;
identifying building damage categories and extracting indicators; and
assessing building risks by staged processes.

16. The non-transitory computer readable medium of claim 15, wherein the identifying building damage categories and extracting indicators comprises interpolating a cumulative deformation surface based on measurements obtained from the MT-InSAR method.

17. The non-transitory computer readable medium of claim 16, wherein deformation planes beneath each building are treated as triggers for building damages.

18. The non-transitory computer readable medium of claim 16, wherein types of damages vary depending on types of settlement areas.

19. The non-transitory computer readable medium of claim 15, wherein the assessing building risks by staged processes comprises:
setting a third predetermined threshold for maximum settlement to identify building with a Negligible level of damage directly;
calculating tensile strain; and
determining building damage levels.

20. The non-transitory computer readable medium of claim 19, wherein the third predetermined threshold is set to 8 mm.
